(19) United States
(12) Patent Application Publication
(10) Pub. No.: US 2016/0328729 A1
(43) Pub. Date: Nov. 10, 2016

(54) SYSTEMS AND METHODS FOR PROVIDING A CONSUMER DISCOUNT

(71) Applicant: InstaMed Communications, LLC, Philadelphaia, PA (US)

(72) Inventor: Christopher D. SEIB, Newport Beach, CA (US)

(21) Appl. No.: 15/145,216

(22) Filed: May 3, 2016

Related U.S. Application Data
(60) Provisional application No. 62/158,816, filed on May 8, 2015.

(51) Int. Cl. G06Q 30/02

(52) U.S. Cl. CPC G06Q 30/0207; G06Q 50/22

(57) ABSTRACT

Systems and methods for automatically collecting a payment are disclosed. A processing device receives a first transmission including discount option(s) from a healthcare provider and a second transmission including a record of a service rendered to a patient and an amount due. The second transmission may be received from a remote device associated with the healthcare provider. The processing device determines one or more payment discounts based on the amount due, whether the user intends to pay in full, when the user intends to pay, and the discount option(s). The processing device receives payment discount(s) selected by the patient and a payment amount and a discount amount based on the selected discounts and the amount due. The processing device processes the payment amount and generates a posting record including the payment amount and the discount amount indicating that the amount due is fully paid.

### CROSS REFERENCE TO RELATED APPLICATIONS

This application claims the benefit of U.S. Provisional Application No. 62/158,816, entitled “System and Method for Providing a Consumer Discount” and filed on May 8, 2015, the contents of which are incorporated by reference in their entirety as if fully set forth herein.

### BACKGROUND

The present disclosure is generally related to medical bill processing and, more specifically, to providing a consumer discount during medical bill processing.

After medical services have been rendered to a patient, collecting payment from a patient may be difficult because, for some patients, there is little incentive to pay a medical bill promptly for services that have already been rendered. Additionally, in medical billing, there is often uncertainty as to the amount that an insurance provider or other responsible party owes or will pay for the rendered services. Thus, a large volume of unpaid bills exists in the medical industry because patients may not pay the correct amount due at the time of service, may be late in paying an issued bill or invoice for medical services provided, or may simply refuse to pay a medical bill.

For example, a patient may see a physician for an emergency visit. At the time of the service, the patient has little to no incentive to pay his medical bill immediately. For example, the patient may rely on his insurance coverage to pay the medical bill. Typically, though, the patient's insurance only pays a portion of the bill. In some cases, the patient and/or the physician may be unable to determine how much of the medical bill will be paid by his insurance and defers payment until later as a result. When a request for payment is later sent to the patient to collect the unpaid funds, the patient may delay payment or refuse payment altogether. In such a situation, a physician or a medical practice may acquire the services of a debt collection agency to collect any unpaid fees. Typically, hiring such an agency costs the physician or medical practice more than it would to provide an incentive to the patient to pay his portion of the medical bill prior to a due date.

To provide an incentive to a patient to pay their bill early, some service providers offer a discounted rate if the patient pays at the time of service, e.g., before they leave a physician's office following a check-up or other service. However, if the patient is unwilling or unable to pay at the time of service, this discount is forfeited, as the service provider will now charge the total fee due regardless of promptness of payment by the patient. However, as noted above, the service provider now has a similar problem of late or non-submitted payments from patients. Thus, there is a need for providing discounted payment options to a patient after the time of service while accounting for and handling any potential billing issues that may arise from the discount options.

### SUMMARY

In an embodiment, a system may include a processor and a non-transitory, processor-readable storage medium. The non-transitory, processor-readable storage medium may include one or more programming instructions that, when executed, cause the processor to receive a first transmission including one or more discount options from a healthcare provider, receive a second transmission including a record of a healthcare provider's rendered service provided to a patient and an amount due from a first remote device associated with the healthcare provider, determine one or more payment discounts based on at least the amount due, whether the user intends to pay in full, when the user intends to pay, and the one or more discount options received from the healthcare provider, receive, from the patient, an indication of at least one or more determined payment discounts to apply to the amount due, determine a payment amount and a discount amount based on the amount due and the patient-selected one or more payment discounts, process the payment amount, and generate a posting record comprising the payment amount and the discount amount such that the amount due is indicated as paid in full.

In an embodiment, a method may include receiving, by a processing device, a first transmission comprising one or more discount options from a healthcare provider; receiving, by the processing device, a second transmission comprising a record of a healthcare provider's rendered service provided to a patient and an amount due from a first remote device associated with the healthcare provider; determining, by the processing device, one or more payment discounts based on at least the amount due, whether the user intends to pay in full, when the user intends to pay, and the one or more discount options received from the healthcare provider; receiving, by the processing device, an indication from the patient of at least one or more determined payment discounts to apply to the amount due; determining, by the processing device, a payment amount and a discount amount based on the amount due and the patient-selected one or more payment discounts; processing, by the processing device, the payment amount; and generating, by the processing device, a posting record comprising the payment amount and the discount amount such that the amount due is indicated as paid in full.

### BRIEF DESCRIPTION OF THE DRAWINGS

Aspects, features, benefits and advantages of the embodiments described herein will be apparent with regard to the following description, appended claims, and accompanying drawings where:

FIG. 1 depicts a sample system overview of a discount payment processing environment according to an embodiment.

FIG. 2 depicts a sample discounted medical bill payment system according to an embodiment.

FIG. 3 depicts a sample process for determining and applying provider discounts to a medical bill according to an embodiment.

FIG. 4 depicts a sample process for receiving and processing discounted payments received from a patient according to an embodiment.

FIG. 5 depicts a block diagram of a sample computing system that may be used to contain or implement program instructions according to an embodiment.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The following terms shall have, for the purposes of this application, the respective meanings set forth below.

An “electronic device” refers to a device that includes a processor and a tangible, computer-readable memory or storage device. The memory may contain programming instructions that, when executed by the processor, cause the processor to perform one or more operations. Examples of electronic devices include personal computers, supercomputers, gaming systems, televisions, mobile devices, medical devices, recording devices, and/or the like.

A “mobile device” refers to an electronic device that is generally portable in size and nature, or is capable of being operated while in transport. Accordingly, a user may transport a mobile device with relative ease. Examples of mobile devices include pagers, cellular phones, feature phones, smartphones, personal digital assistants (PDAs), cameras, tablet computers, phone-tablet hybrid devices (“phablets”), laptop computers, netbooks, ultrabooks, global positioning satellite (GPS) navigation devices, in-dash automotive components, media players, watches, portable medical devices, and the like.

A “computing device” is an electronic device, such as a computer, a processor, a memory, and/or any other component, device, or system that performs one or more operations according to one or more programming instructions.

A “medical service provider” is, collectively or individually, a medical laboratory performing medical tests and evaluating medical samples, a hospital, a medical clinic, a primary care physician (PCP), a medical specialist such as, for example, a thoracic surgeon, a dermatologist, or a dentist, employees of the PCP, specialist, laboratory, hospital, or clinic, employees of the practice group to which the PCP or specialist belong, or any other similar or related entity. Typical employees may include, but are not limited to, nurses, interns, student doctors, resident doctors, physician's assistants, laboratory technicians, filing clerks, office managers, and receptionists.

A “medical bill” is a record of healthcare products or services provided to an individual patient and their associated costs that are recorded to report the delivery of the products or services. The medical bill may be recorded by a processor-readable storage medium. In an embodiment, the medical bill may be recorded electronically in a digital format. Medical bill data is the information in the medical bill. In an embodiment, the medical bill may include a paper document or an electronic document.

The present disclosure relates generally to systems and methods that are configured to provide a consumer with a discount option for paying their bills from, for example, a medical provider in a timely manner. A healthcare provider may have control over which discounts they would offer, and under what circumstances they would offer the discounts. For example, a healthcare provider may offer a 30% discount if a consumer pays their total bill at the time of service. The same healthcare provider may also offer a 20% discount if the bill is paid within a set time period, e.g., within seven days of receiving the bill. Additionally, the healthcare provider may offer a discount if a consumer sets up a payment plan. For example, the healthcare provider may offer a 10% discount if a consumer sets up a payment plan for an amount owed above a certain threshold, e.g., above $500. The present disclosure further includes processes and techniques for updating a posting record associated with a consumer's medical bill such that the discount offered by the healthcare provider is accounted for and a total amount due on the medical bill is reflected as paid in full.

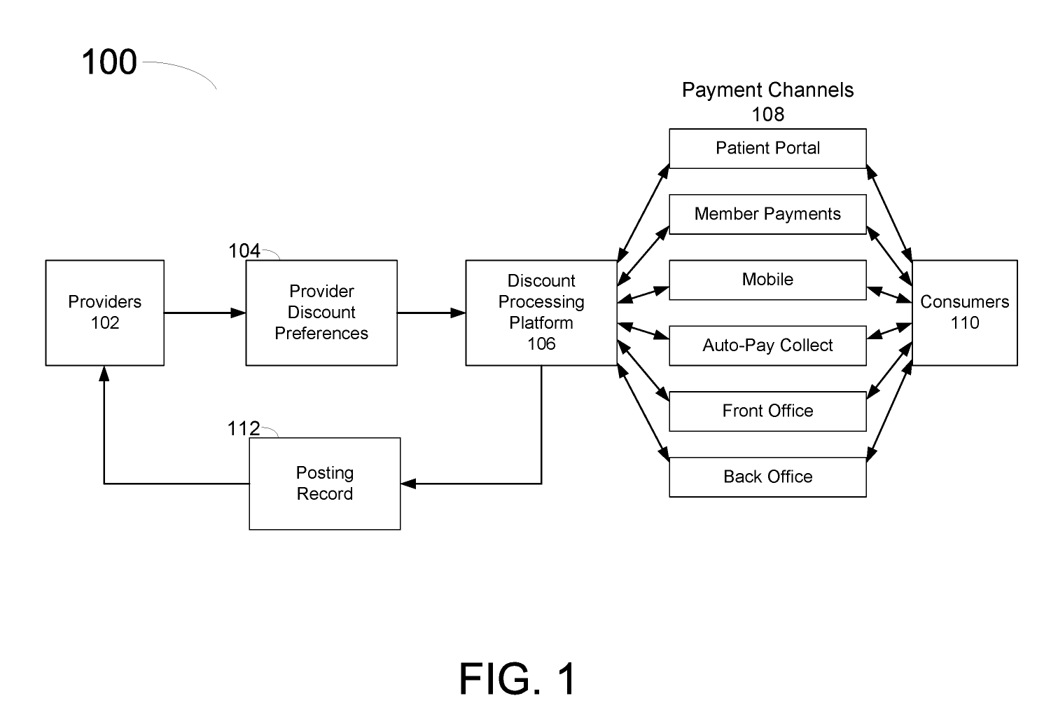

FIG. 1 depicts a sample system overview for a healthcare payment and processing network 100 for receiving discount parameters and providing discounted payment options to one or more consumers. It should be noted that network 100 as shown in FIG. 1 is directed to a network for receiving medical bill information for medical services and procedures and processing medical bill and payment information. However, a medical bill payment system is shown by way of example only and the processes and features as described herein can be applied to alternative billing, payment and collection environments.

Referring again to FIG. 1, the network 100 may include a plurality of providers 102. Each provider 102 may be a member of a similar medical association such as a hospital or healthcare provider network, or may subscribe to the same billing and processing contractor. A provider 102 may opt to enter a discounted payment system as provided by their billing and processing contractor.

As noted above, the discounted payment system may provide a way for the provider 102 to determine one or more specific discounts they want to offer, and provide a set of provider discount preferences 104 to, for example, a discount processing platform 106 associated with the billing and processing contractor. In an example, a provider 102 may set up an account in the discounted payment system that allows the provider to access the discount processing platform 106 and transmit their discount preferences 104. Alternatively, a person, such as a customer representative, working for or associated with the billing and processing contractor may contact the provider 102 directly to obtain their discount preferences 104 and provide those preferences to the discount processing platform 106.

The discount processing platform 106 may receive the discount preferences 104 and may process a medical bill to determine one or more available discount options based upon the provider discount preferences. A medical bill may be updated accordingly. The discount processing platform 106 may provide the updated medical bill and discounted billing information to a consumer 110 via one or more payment channels 108. For example, the discount processing platform 106 may provide the information via an e-commerce portal. E-commerce portals may include, for example, a patient portal which a consumer 110 can use to access a website hosted by the billing and processing contractor for making a payment to the provider 102, a member payment portal such as a third party site (e.g., a health plan or insurance provider website) which acts as an intermediary between the consumer and the provider, and a mobile payment site or application which the user can access on, for example, a mobile device for providing payment information to a third party or directly to the provider for processing. Additionally, the consumer 110 may access an automatic payment channel 108 such as a third party billing service which automatically charges an account (e.g., a credit card account) associated with the consumer if the balance owed satisfies one or more criteria (e.g., is under a certain dollar amount). The consumer 110 may also submit payment via one or more retail environments such as directly to the provider's front office or to a provider's back office by, for example, mailing in payment or calling the provider 102 to provide payment information.

Upon receiving the amount owed by the consumer 110 (e.g., the total value of the medical bill minus any discount amount), the discount processing platform 106 may generate and transmit a posting record 112 back to the provider. The posting record 112 may include verification that the medical bill has been paid in full, e.g., that the discount amount plus the amount paid by the consumer 110 equals the amount due on the original medical bill submitted by the provider 102.

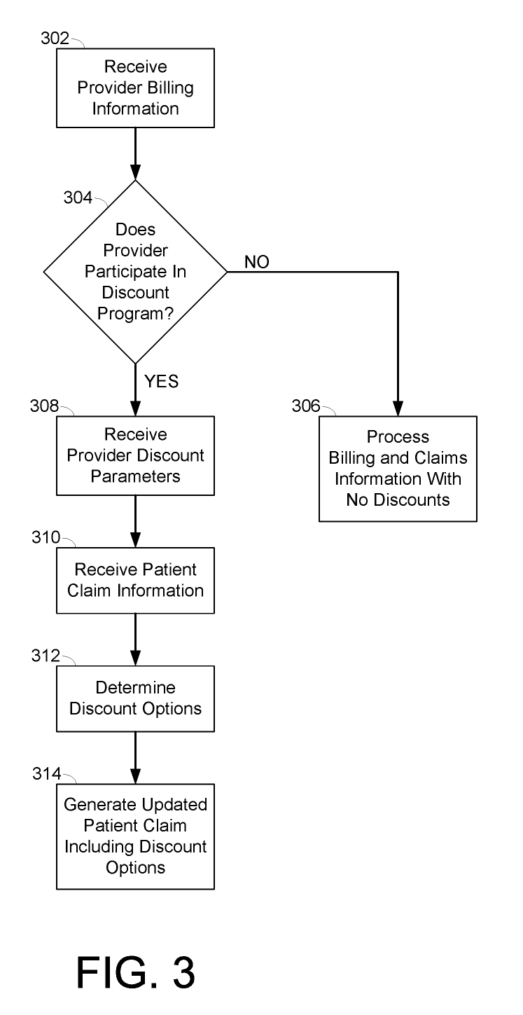

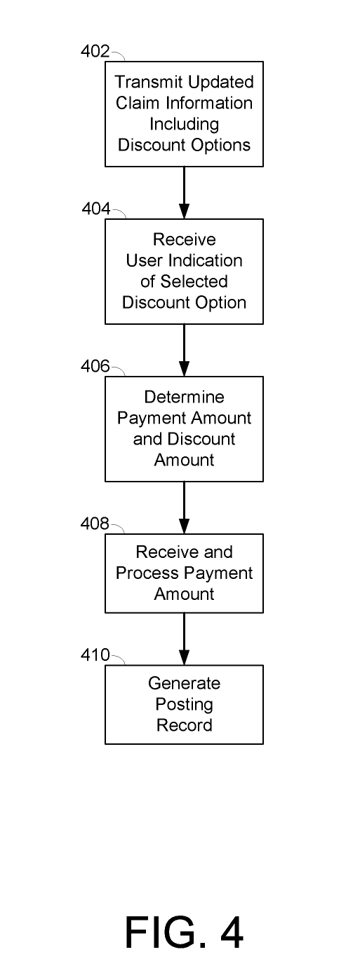

Additional details related to the functionality and processes performed by or associated with the discounted payment system as, for example, described in FIG. 1 are provided in the discussions of FIGS. 3 and 4 below.

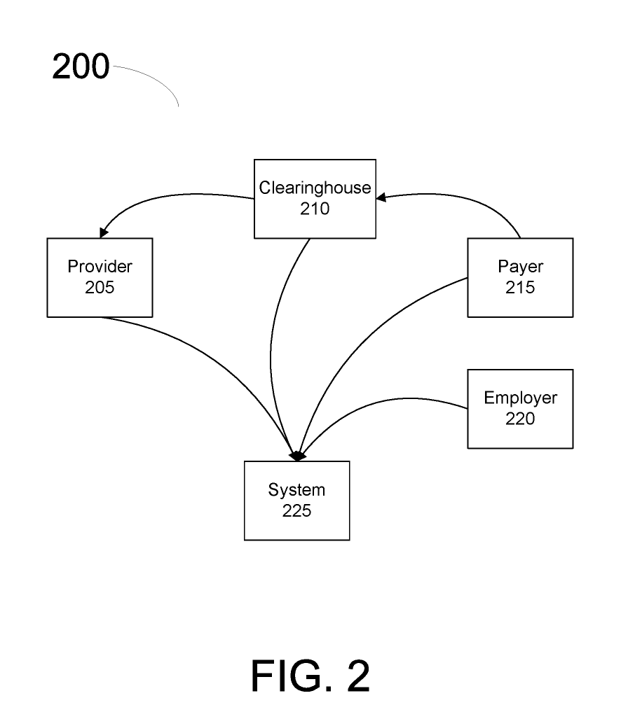

FIG. 2 depicts a sample discounted medical bill payment system 200 according to an embodiment. For example, the medical bill payment system 200 as shown in FIG. 2 may include, for example, the provider 102 and the discount processing platform 106 as shown in FIG. 1. For example, provider 205 as shown in FIG. 2 may represent a sample provider 102 as shown in FIG. 1, and a payment system 225 may represent the discounted payment platform 106 of FIG. 1.

The payment system 225 may include, for example, a processor and a processor-readable storage medium. The provider 205 may be configured to operably connect to and communicate with the payment system 225.

Similarly, the payment system 225 may be operably connected to and in communication with a payer 215. The payer 215 may be configured to receive and process one or more medical bills. As used herein, the payer 215 may include, but is not limited to, a third party administrator (TPA), a health care administrator, a health maintenance organization (HMO), and/or a preferred provider organization (PPO).

A clearinghouse 210 may provide an intermediary between the provider 205 and the payer 215. The clearinghouse 210 may be configured to collect and distribute information to one or more medical bills. For example, the clearinghouse 210 may perform medical bill processing, medical bill filtering, medical bill verifying and/or other services necessary for a provider and/or a payer.

In an embodiment, the discounted medical bill payment system 200 may include one or more processing devices associated with an employer 220. As used herein, the employer 220 may be a person or entity that hires an employee. Within the discounted medical bill payment system 200, an employee may be a patient of the provider 205. The employer 220 may purchase some or all of the insurance that covers some or all of the employee's health care costs. Similarly, a payer 215 such as a TPA may pay a portion or the entire payment of an employee's medical bill to the provider 205.

FIG. 3 depicts a sample process for receiving provider discount preference information and determining and applying discount options to a medical bill. The process as described in FIG. 3 may be performed by, for example, a medical bill processing device associated with the billing and processing contractor such as the discount processing platform 106 as shown in FIG. 1.

Referring again to FIG. 3, the medical bill processing device may receive 302 provider billing information. For example, the information may include registration information or updated billing information from the provider such that the billing and processing contractor can accurately and efficiently process medical bills. Additionally, the billing information may include an indication of whether the provider is participating or wants to participate in a discount payment program. The medical bill processing device may determine 304 whether the provider has opted to participate in the discount payment program. If the medical bill processing device determines 304 that the provider is not participating, the medical bill processing device may process 306 the billing information normally without any discount options.

Conversely, if the medical bill processing device does determine 304 that the provider is participating in the discount payment program, the medical bill processing device may receive 308 the provider discount parameters from the provider. For example, the provider discount parameters may include at least:
Balance amount
Number of Days from Statement Date or Consumer Notification Date
Use of Payment or Installment Plan
Use of Pre-Arranged “Save of File” (e.g., auto-pay programs)
Specific Payment Method Used (e.g., credit card brand, eCheck, etc.)
Type of Service Provided or Procedure Codes (e.g., providing a list of eligible and ineligible services)
Billing Provider Tax ID or Organization Identifier
Service Provider Tax ID (rendering provider identifier)
   It should be noted that this list of discount parameters is provided by way of example only, and may be modified based upon the implementation of the discount payment program and the personal preferences of the service provider.

In some cases, the provider may offer a self-payment discount to a patient if the patient does not seek to submit a coverage request to an insurance company. Such a discount may be applied in advance of submission of the medical bill to the medical bill processing device and/or may be applied in addition to or instead of one or more other discounts.

The medical bill processing device may also receive 310 patient medical bill information from a provider, the medical bill information including, for example, patient identification information, what type of service was provided and the cost associated with the service. The medical bill may also include an indication of the portion of the costs that are covered by insurance associated with the patient. Based upon the medical bill information and the discount parameters for the provider, the medical bill processing device may determine 312 one or more discount options and generate 314 an updated medical bill including those discount options for review by the patient. The medical bill processing device may then transmit the updated medical bill to the patient as is shown in FIG. 4.

FIG. 4 depicts a process for receiving and processing discounted payments from a patient. As noted above, a computing device such as the medical bill processing device may transmit 402 the updated medical bill information including the discount options. The notification of the discount options to the patient may be presented in a variety of ways, including in a mailed statement, via an electronic message such as an email or text message, upon a patient logging into a consumer portal such as a patient portal, a mobile payment application, or a member payment portal, or at the provider's office at the time of service.

The medical bill processing device may receive 404 a user indication of a selected discount option and, based upon the user selection, determine 406 the payment amount (e.g., the portion of the amount due to be paid by the patient) and the discount amount (e.g., the portion of the amount due associated with the selected discount option).

For example, the medical bill processing device may determine 406 the discount amount and present the discount amount to the patient as a “multi-line” transaction on the medical bill. One line of the transaction may include the discount amount reflecting the amount of the medical bill corresponding to the discount option selected by the patient. Another line of the transaction may include the payment amount owed by the patient at the time of paying. A third line of the transaction may show that the discount amount plus the payment amount equals the original total balance due.

The medical bill processing device may receive 408 the payment amount from the patient and process the medical bill accordingly. Payment may be delivered to the service provider via standard capture and settlement methods such that the service provider receives the discounted payment amount paid by the patient. The medical bill processing device may then generate 410 a posting record such that the service provider's records indicate that the medical bill has been paid in full.

Alternatively or additionally, the medical bill processing device may automatically apply the discount as determined based upon the discount selected by the patient. For example, if the patient elects to use a particular credit or debit card to pay the bill, the medical bill processing device may automatically apply a discount when charging the credit or debit card. Similarly, if the patient has previously enrolled in an automatic payment system, the medical bill processing device may automatically apply a discount when charging the automatic payment system.

As noted above, the payment transaction may be reflected as a multi-line transaction. Similarly, in the posting record, at least one line item may represent the discount amount (as determined based upon the patient's selected discount option) and at least one line item may represent the discounted payment amount the patient paid. Thus, the posting record reflects that the total amount due has been satisfied in full (i.e., the discount amount plus the discounted payment amount). As such, when doing internal accounting or auditing, the patient's medical bill will appear to be paid in full in the provider's record while the patient paid a discounted portion of the original total balance due.

It should be noted that the processes illustrated in FIGS. 3 and 4 and described above are provided by way of example only. Additional or alternative features and functions may be incorporated into the processes as described herein based upon various implementations. For example, a discount payment program may provide additional discounts for a consumer based upon various additional criteria. For example, as briefly outlined above, the discount payment program may offer a reduction of a certain percentage if a consumer uses a particular brand of credit or debit card. Such a discount may be provided by a third party (e.g., a credit card company) and would not be funded by a service provider. Similarly, an insurance company may offer members additional discounts (in addition to any discounts offered by a service provider) for certain procedures or routine visits. Likewise, an employer may offer employees discounts (in addition to or in lieu of any discounts offered by a service provider) for certain procedures or routine visits. Such additional discounts would be provided by, for example, the insurance company or the employer, and would not be funded by the service provider.

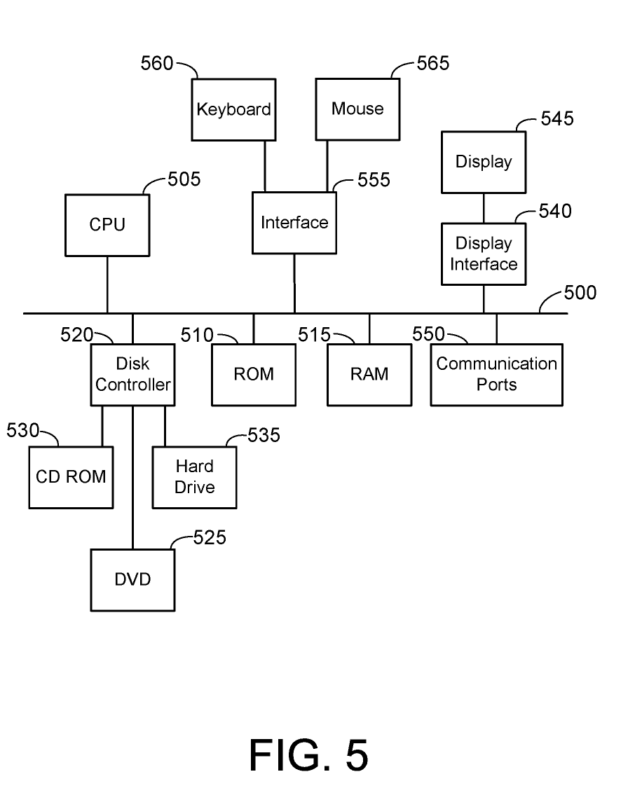

FIG. 5 depicts a block diagram of illustrative internal hardware that may be used to contain or implement program instructions, such as the process steps discussed herein, according to various embodiments. A bus 500 may serve as the main information highway interconnecting the other illustrated components of the hardware. A CPU 505 is the central processing unit of the system, performing calculations and logic operations required to execute a program. The CPU 505, alone or in conjunction with one or more of the other elements disclosed in FIG. 5, is an illustrative processing device, computing device or processor as such terms are used within this disclosure. Read only memory (ROM) 510 and random access memory (RAM) 515 constitute illustrative memory devices (such as, for example, processor-readable non-transitory storage media).

A controller 520 interfaces with one or more optional memory devices 525 to the system bus 500. These memory devices 525-535 may include, for example, an external or internal DVD drive 525, a CD ROM drive 530, a hard drive 535, flash memory, a USB drive, or the like. As indicated previously, these various drives and controllers are optional devices.

Program instructions, software, or interactive modules for providing the interface and performing any querying or analysis associated with one or more data sets may be stored in the ROM 510 and/or the RAM 515. Optionally, the program instructions may be stored on a tangible computer-readable medium such as a compact disk, a digital disk, flash memory, a memory card, a USB drive, an optical disc storage medium, such as a Blu-Ray™ disc, and/or other non-transitory storage media.

An optional display interface 540 may permit information from the bus 500 to be displayed on the display 545 in audio, visual, graphic, or alphanumeric format, such as the interface previously described herein. Communication with external devices, such as a print device, may occur using various communication ports 550. An illustrative communication port 550 may be attached to a communications network, such as the Internet, an intranet, or the like.

The hardware may also include an interface 555 that allows for receipt of data from input devices such as a keyboard 560 or other input device 565 such as a mouse, a joystick, a touch screen, a remote control, a pointing device, a video input device and/or an audio input device.

The hardware may also include a storage device such as, for example, a connected storage device, a server, and an offsite remote storage device. Illustrative offsite remote storage devices may include hard disk drives, optical drives, tape drives, cloud storage drives, and/or the like. The storage device may be configured to store data as described herein, which may optionally be stored on a database. The database may be configured to store information in such a manner that it can be indexed and searched, as described herein.

The computing device of FIG. 5 and/or components thereof may be used to carry out the various processes as described herein.

As noted above, the present disclosure is generally directed to medical bills and healthcare providers by way of illustrative example only. The processes and techniques as described herein may be applied in a variety of businesses and environments where a consumer is billed for received services, and the specific processes and functions as taught herein may be adjusted or otherwise altered to accommodate alternative embodiments.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications.

Various presently unforeseen or unanticipated alternatives, modifications, variations or improvements therein may be subsequently made by those skilled in the art, each of which is also intended to be encompassed by the disclosed embodiments.

What is claimed is:

1. A system comprising:
a processor; and
a non-transitory, processor-readable storage medium, wherein the non-transitory, processor-readable storage medium comprises one or more programming instructions that, when executed, cause the processor to:
receive a first transmission comprising one or more discount options from a healthcare provider,
receive a second transmission comprising a record of a healthcare provider's rendered service provided to a patient and an amount due from a first remote device associated with the healthcare provider,
determine one or more payment discounts based on at least:
the amount due,
whether the user intends to pay in full,
when the user intends to pay, and
the one or more discount options received from the healthcare provider,
receive, from the patient, an indication of at least one or more determined payment discounts to apply to the amount due,
determine a payment amount and a discount amount based on the amount due and the patient-selected one or more payment discounts,
process the payment amount, and
generate a posting record comprising the payment amount and the discount amount such that the amount due is indicated as paid in full.

2. The system of claim 1, wherein the non-transitory, processor-readable storage medium further comprises one or more programming instructions that, when executed, cause the processing device to receive the payment amount from a payer.

3. The system of claim 2, wherein the non-transitory, processor-readable storage medium further comprises one or more programming instructions that, when executed, cause the processing device to transmit at least a portion of the payment amount to the healthcare provider.

4. The system of claim 1, wherein the non-transitory, processor-readable storage medium further comprises one or more programming instructions that, when executed, cause the processing device to transmit the posting record to the healthcare provider.

5. The system of claim 1, wherein the one or more programming instructions that, when executed, cause the processing device to generate the posting record comprise one or more programming instructions that, when executed, cause the processing device to transform payment data corresponding to the payment amount and discount data corresponding to the payment discount into the posting record.

6. The system of claim 1, wherein the non-transitory, processor-readable storage medium further comprises one or more programming instructions that, when executed, cause the processing device to:
generate a transmission comprising the payment amount; and
transmit the transmission to one or more payment channel providers.

7. The system of claim 6, wherein the non-transitory, processor-readable storage medium further comprises one or more programming instructions that, when executed, cause the processing device to receive a confirmation message from the one or more payment channel providers that the payment amount has been paid.

8. The system of claim 1, wherein the non-transitory, processor-readable storage medium further comprises one or more programming instructions that, when executed, cause the processor to transmit a receipt to a payer.

9. The system of claim 1, wherein at least a portion of the amount due corresponds to a patient responsibility amount.

10. The system of claim 1, wherein the non-transitory, processor-readable storage medium further comprises one or more programming instructions that, when executed, cause the processor to receive a third transmission comprising a request from a user to register for automatic payment of healthcare-related debts.

11. The system of claim 10, wherein the one or more programming instructions that, when executed, cause the processing device to determine the payment discount comprise one or more programming instructions that, when executed, cause the processing device to:
determine whether the user has registered for automatic payment; and
if the user has registered for automatic payment, automatically adjust the payment discount accordingly.

12. A method comprising:
receiving, by a processing device, a first transmission comprising one or more discount options from a healthcare provider;
receiving, by the processing device, a second transmission comprising a record of a healthcare provider's rendered service provided to a patient and an amount due from a first remote device associated with the healthcare provider;
determining, by the processing device, one or more payment discounts based on at least:
the amount due,
whether the user intends to pay in full,
when the user intends to pay, and
the one or more discount options received from the healthcare provider;
receiving, by the processing device, an indication from the patient of at least one or more determined payment discounts to apply to the amount due;
determining, by the processing device, a payment amount and a discount amount based on the amount due and the patient-selected one or more payment discounts;
processing, by the processing device, the payment amount; and
generating, by the processing device, a posting record comprising the payment amount and the discount amount such that the amount due is indicated as paid in full.

13. The method of claim 12, further comprising receiving, by the processing device, the payment amount from a payer.

14. The method of claim 13, further comprising transmitting, by the processing device, at least a portion of the payment amount to the healthcare provider.

15. The method of claim 13, further comprising transforming, by the processing device, payment data corresponding to the payment amount and discount data corresponding to the payment discount into a posting record.

16. The method of claim 15, further comprising transmitting, by the processing device, the posting record to the healthcare provider.

17. The method of claim 12, further comprising:
generating, by the processing device, a third transmission comprising the payment amount; and
transmitting, by the processing device, the third transmission to one or more payment channel providers.

18. The method of claim 17, further comprising receiving, by the processing device, a confirmation message from the one or more payment channel providers that the payment amount has been paid.

19. The method of claim 12, further comprising transmitting, by the processing device, a receipt to a payer.

20. The method of claim 12, wherein at least a portion of the amount due corresponds to a patient responsibility amount.

21. The method of claim 12, further comprising receiving, by the processing device, a second transmission comprising a request from a user to register for automatic payment of healthcare-related debts.

22. The method of claim 21, wherein determining the payment discount further comprises:
determining, by the processing device, whether the user has registered for automatic payment; and
if the user has registered for automatic payment, automatically adjusting the payment discount accordingly.
